(19) United States
(12) Patent Application Publication
(10) Pub. No.: US 2012/0056385 A1
(43) Pub. Date: Mar. 8, 2012

(54) SEALING ELEMENT FOR SEALING FLANGE SURFACES ON INTERNAL COMBUSTION ENGINES

(75) Inventor: Rolf Prehn, Wipperfuerth (DE)

(73) Assignee: Federal-Mogul Sealing Systems GmbH, Herdorf (DE)

(21) Appl. No.: 13/319,504

(22) PCT Filed: Dec. 18, 2009
(86) PCT No.: PCT/DE2009/001786

§ 371 Date: Nov. 8, 2011

(30) Foreign Application Priority Data
May 8, 2009 (DE) 1020090204903

(51) Int. Cl. F02F 11/00

(52) U.S. Cl. 277/594

(57) ABSTRACT

A sealing element for sealing flange faces on internal combustion engines, comprising at least one annular metal profiled body, characterized in that the profiled body is made of a wire and comprises at least one core region and at least one bending region, the material thickness of the wire is designed to be greater in the core region than in the respective bending region, and the wire in the core region is provided with at least one connecting means for direct or indirect connection to at least one further component. A radial cross-section of the sealing element is banana-shaped with a center region of the banana-shape being the sealing element core region and an end region of the banana-shape being the bending regions.

### BACKGROUND OF THE INVENTION

The invention relates to a sealing element for sealing flange faces on internal combustion engines, comprising at least one annular metal profiled body.

In multi-layer metal cylinder head gaskets, it is known to connect the various layers to each other using suitable joining methods (for example clinching, welding, riveting). These layers may comprise beads or other sealing elements in the form of polymeric gaskets so as to seal fluids or gases.

Such sealing elements, for one, must have sufficient spring properties to compensate for static irregularities in the sealing surfaces and dynamic sealing gap vibrations (when used as cylinder head gaskets). Secondly, these gaskets must be rigid enough so as not to yield in such a way that insufficient elasticity causes the sealing element to break.

It is also known to use profiled metal rings so as to generate sufficient pre-stress at the combustion chamber edge of an internal combustion engine. The principle employed for this purpose is to plastically deform a metal ring so that the sealing gap is closed. A key prerequisite for operating such a gasket in this case, however, is that no sealing gap movement occurs, because a plastically deformed metal ring has almost no significant elasticity that could be utilized to compensate for the sealing gap vibrations.

GB 979,408 discloses a seal for a cylinder sleeve that is formed by an annular profiled metal body which, as seen over the radial wall thickness, has a uniform height and a substantially symmetrical cross-sectional profile. A cylinder head gasket, which has a radial free space for receiving this profiled body, is disposed between the cylinder head and cylinder block. Given the outwardly curved contour of the sealing element, which exceeds the axial height of the cylinder head gasket, the profiled body is elastically deformed within the groove receiving the same when the cylinder head is bolted to the cylinder block, so that, at the maximum deformation pressure, the profiled body is still at a defined distance from the groove base of the receiving groove, with the exception of the lateral receiving regions of this body. The profiled body is produced from stainless steel and comprises, at least at the groove base, sharp-edged transition regions from the respective radial end boundary into the associated axial flank. To this end, the sharp-edged transition regions ensure that the surface pressure in the region of the two sealing lines is sufficiently high.

A sealing ring for sealing cylinder covers on internal combustion engines is known from DE 12 53 950, comprising at least one layer of sheet metal, wherein the cross-section of the layer has the shape of a segment of a circle and the inside edge and outside edge are arranged in one plane. Again, the axial height of the sealing ring, as seen over the entire radial wall thickness thereof, has a uniform design. Moreover, this prior art proposes that the sealing ring be composed of two sealing rings that are laterally reversed from, and in contact with, each other along a central diameter.

### SUMMARY OF THE INVENTION

It is the object of the invention to provide a novel sealing element, which usually is annular, for sealing flange faces in internal combustion engines, with this sealing element having sufficient spring properties to compensate for static irregularities of the respective sealing surface and dynamic sealing gap vibrations, if needed. Moreover, the sealing element must be rigid enough so as not to yield in such a way that insufficient elasticity causes the sealing element to break.

This object is achieved by providing a sealing element for sealing flange faces in internal combustion engines comprising at least one annular metal profiled body, wherein the profiled body is produced from a wire and has a cross-section comprising at least one core region and at least one bending region, the material thickness of the wire in the core region is greater than that in the bending region, and the wire in the core region is provided with at least one connecting means for direct or indirect connection to at least one further component and the cross-section of the unstressed profiled body is like the longitudinal axial cross-section of a banana, a central portion corresponding to the aforementioned core portion and end portions corresponding to the aforementioned bending portions, the height of the sealing ring at the bending portions, taken parallel to the axis of the sealing element, being greater than the height of the sealing ring at the core portion, also taken parallel to the axis of the sealing element.

Advantageous refinements of the subject matter of the invention are disclosed in the dependent claims.

The subject matter of the invention is based on the technical embodiment of a bending beam. By applying forces, or bracing such a geometry between two plates (for example, between the cylinder block and cylinder head), a load is applied to the bending beam from above, approximately at the center, and the force is supported by the two support points at the outside of the underside. This allows not only for the support points to be exactly defined, but also for the force distribution between the support points to be adjusted. Moreover, the thickness of the bending beam correlates with the rigidity of the system and the spring properties associated with the system (material selection).

The subject matter of the invention makes it possible, as necessary, to bring identical components (profiled bodies) into operative connection with each other in the region of the connecting means. The shape of the components, however, can also be different from that of the profiled body. The connecting means are designed to match each other when directly connecting to identical profiled bodies/differently designed components. The profiled bodies/components can thus be combined with each other, or stacked, in a simple manner.

Attaching, or introducing, the connecting means in the core region of the sealing element, which is to say outside of the bending regions, has the following advantage:
by stacking two profiled bodies/components, double the spring deflection can be achieved as compared to a single profiled body;
by providing the connecting means, the introduction of force into the profiled body/component can be decisively influenced. The spring-force level can thus be adjusted and the power flow can be optimized;
the connecting means allow such profiled bodies/components to be mechanically anchored or mounted directly in impressions or recesses on functional layers of a gasket or a carrier.

According to a further concept of the invention, it is also possible to use additional connecting elements, or intermediate pieces, to indirectly connect individual profiled bodies/components, whereby arbitrary installation heights can be implemented for the sealing element.

According to one concept of the invention, the connecting means is formed by surface regions that are offset from each other. In a simple embodiment, two surface regions may be present, which run parallel to each other and are provided at different heights in the core regions.

Also conceivable are concavely and convexly designed surface regions on the individual profiled bodies/components/intermediate pieces so as to bring about a direct or indirect connection of the respective components.

Taking this principle as a basis, according to the invention, more specifically:
the radial cross-section of the wire is profiled so that it approximately corresponds to the longitudinal axial cross-section of a banana;
the cross-section of the wire is such that the radial end portions of the annular sealing element form two upper and two lower bending regions, respectively, forming a recess;
the profile of the wire is such that a thickened core region of the sealing element is thicker than the rest of the sealing element in the axial direction of the sealing element, and bending regions are formed at the ends of the radial cross-section, which in the starting state, i.e., initially, in the uninstalled unstressed sealing element, exceed the height of the core region in the axial direction of the sealing element.

It is particularly advantageous, as compared to the prior art, for at least the regions of the radial extremities of the respective bending regions to be provided with a rounded shape. This prevents the radial ends from digging into the groove that receives the sealing element, particularly with dynamic sealing gap vibrations.

When a banana-shaped geometry is used for the wire, the profile has a maximum cross-section at the center. The cross-section is tapered (uniformly or non-uniformly) toward the two ends. This means that the elastic ends bend when subjected to a load. With full compression, such as can occur in a cylinder head gasket, the center of the lower arch of the banana-shaped profile rests on the respective flange face, or the groove base, so that only this central region offers support. This mechanism of action creates what is referred to as a stopper function. Moreover, an additional sealing line is defined by the stopper region. This additional sealing line is advantageous in particular for sealing at comparatively high pressures because, contrary to the prior art, sharp-edged transition regions can be eliminated when using two sealing lines.

This mode of action corresponding to the classic bending beam can also be applied to the additional profiles underlying the subject matter of the invention. The outer ends forming bending regions bend elastically until, with full compression, once again, only the central region offers support.

The subject matter of the invention thus combines a spring element with an integrated stopper element. The stopper height, or the installation height, is thus determined by the largest cross-section, or the largest cross-sections, if several sub-regions are designed as core regions. The design of the elastic regions defines the spring behavior (and the sealing force) of such a wire profile.

By deliberately designing the profiled wire geometry, for example using FBM, the contour can be selected so that the sealing force at the installation point can be exactly adjusted. This allows compensation for both the static irregularities of the respective flange face and, if needed, dynamic sealing gap vibrations.

If additional micro-sealing should be required, the profiled wire ring can, for example, also be fully, or partially, coated.

According to a further concept of the invention, it may prove to be advantageous to design the wire profile asymmetrically. The force distribution (warpage) at the cylinder head or at the cylinder block can thus be positively influenced.

The sealing element according to the invention can be used both in combination with a cylinder head gasket and a flat gasket, or as an individual sealing element, for example in the exhaust tract of an internal combustion engine.

Depending on whether other sealing elements are to be combined with this wire-shaped media (i.e., flared) sealing element, the requirements resulting for the profiled wire sealing ring according to the invention may vary. By way of example, the following requirements are conceivable:
additional (at least partial) coating for micro-sealing purposes,
joining the profiled wire sealing ring (it is also conceivable for the sealing ring to remain as is, and be unjoined, similar to a piston ring, at the butt),
forming at least one zone or one region that is required for a joining process.

According to a further concept of the invention, the profiled wire is produced from spring steel which advantageously has a yield point of ≧600 MPa.

For this purpose, known austenitic or martensitic, stainless, or corrosion-resistant materials are an obvious choice.

It is likewise conceivable for the wire to be produced from non-stainless steel.

A person skilled in the art will select the suitable material, depending on the particular application.

In general, possible materials for the profiled wire include all spring steels that have inherent elastic or resilient properties.

Austenitic nickel-chromium steels, martensitic chromium steels, bainitic or martensitic carbon steels or polyphase steels shall be mentioned here by way of example. For uses as a sealing element in the exhaust tract, reference shall be made to nickel-based alloys.

The combination of the suitable material, or perhaps the suitable materials, if necessary incorporating a hardening process and/or heat treatment, and the optimized geometry (wire cross-section) assures the function of the sealing element according to the invention, depending on the installation site, for all operating states.

Depending on the application, such as in a passenger car or a commercial vehicle, diesel or gasoline engine, which may be supercharged (for example, turbo or compressor) or not, a different, adapted geometric shape may well be the most beneficial for the sealing element (depending on the combustion pressure and the combustion temperature, different cross-sections are possible).

Using the geometry, the thickness of the respective core region, the cross-section of the respective bending region and the selected material, it is possible to adjust the spring action and installation thickness of the profiled wire sealing ring. Depending on use, as discussed above, a kind of stopper can be implemented with the respective core region of the wire.

By combining various cross-sections, complex geometries can be generated, which have the necessary spring properties with respect to the application.

An additional major advantage of such a sealing element is that the profiled wire being used already has the necessary final dimension and thus only a forming process and, if necessary a joining process, and optionally heat treatment, are required to produce a media sealing element. In some circumstances, mechanical finishing will be required.

For the joining process, which can likewise be employed as necessary, positive, non-positive and bonding methods are conceivable. However, a combination is also possible, for example, a combination of a positive method and a bonding method (for example, mechanical clamping with subsequent gluing of the butt joint).

It is also of essential importance that the selected geometry of the profiled wire, in conjunction with the suitable material, can drastically influence the load/deformation curve of the same. An ideal load deformation curve is represented by a horizontal line in a load deformation graph. This means that, at the beginning, the deformation increases proportionally with a rising load. Starting at a certain load level, the load remains (substantially) the same, while the profile deforms further. Only when the profile has become almost fully deformed does the load rise drastically with little deformation. Ultimately, with full compression, only the load can be increased further, more specifically without bringing about further deformation (plastic deformation, however, is still conceivable). In this connection, the resilience properties of the profiled wire according to the invention are of great importance. The recovery rate is a measure of the ratio of elastic deformation to plastic deformation.

The less the plastic deformation when a load is applied to such a profile, the better the resilience behavior is, when the load is removed. In the present case, using the geometry and the material selection, a load deformation behavior can be achieved that comes very close to the described ideal case. It is thus possible:
to exactly define the installation point of such a sealing element;
to achieve a very high degree of resilient behavior;
to minimize the required bolt load with the same or better sealing function;
to minimize warping at the engine block or other sealing flanges; and
to compensate for larger sealing gap movements or vibrations.

The subject matter of the invention is shown in the drawings based on an exemplary embodiment and is described as follows. In the drawings:

### BRIEF DESCRIPTION OF THE DRAWINGS

FIG. 1 shows two identically designed spaced profiled bodies having mutually facing connecting means;

FIG. 2 shows an assembled sealing element, which is formed by the profiled bodies according to FIG. 1;

FIG. 3 shows the illustration according to FIG. 2, with an additional connecting element/intermediate piece;

FIG. 4 shows the illustration according to FIG. 3 in the installed state;

FIG. 5 is an individual profiled body according to FIG. 1, in operative connection with an alternatively designed component;

FIG. 6 shows the illustration according to FIG. 2 in the installed state.

### DETAILED DESCRIPTION OF THE INVENTION

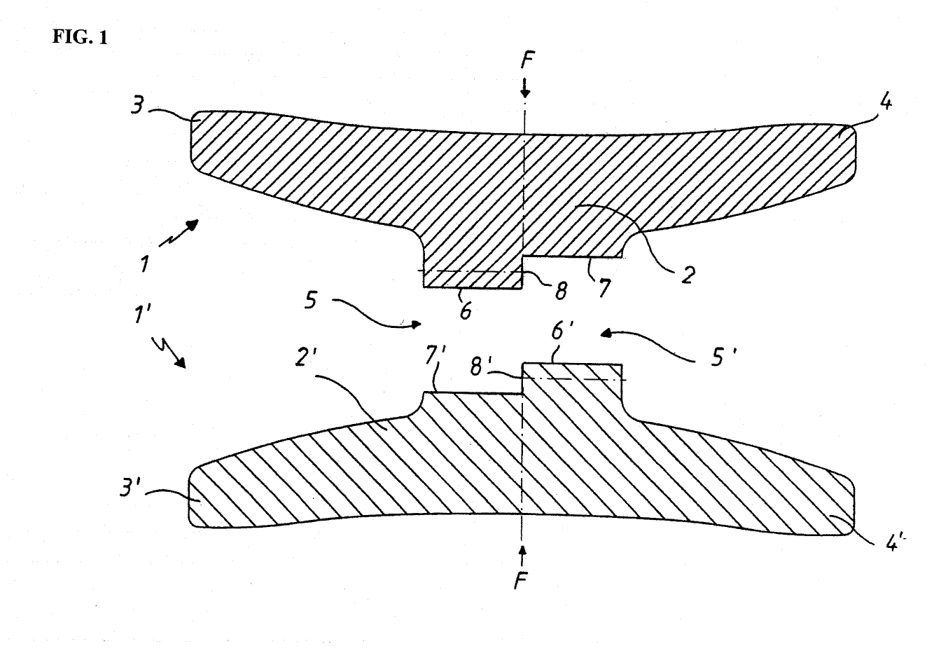

FIG. 1 shows two identically designed sealing elements (profiled bodies 1, 1′), both of which have defined elastic (spring) properties. The profiled bodies 1, 1′ have an annular design and are made of profiled wires. An essential characteristic of the geometries of the profiled bodies 1, 1′ is that these comprise both a core region 2, 2′ which, under usage conditions, (depending on the arrangement of the sealing element) can perform a stopper function, and at least one elastically bendable region 3, 4, 3′, 4′ which, under usage conditions, assures the elastic sealing function of the sealing element 1, 1′. The sealing element 1, 1′ according to FIG. 1 has the largest cross-section at the center (core region 2, 2′). The cross-section is tapered (uniformly or non-uniformly) toward the two ends (bending regions 3, 4, 3′, 4′). This means that, when a load F is applied, the respective bending regions 3, 4, 3′, 4′ bend until, with full compression, only the core region 2, 2′ offers support.

With the aid of the subject matter of the invention, a spring element (bending regions 3, 4, 3′, 4′) is thus combined with a stopper element (core region 2, 2′). The stopper height, or the installation thickness (if only the profiled body is used—without additional layers), is thus determined by the largest cross-section, or the largest cross-sections (if several sub-regions of the sealing element 1, 1′ are designed as core regions), of such a profile. The design of the bending regions 3, 4, 3′, 4′ defines the spring behavior and the sealing force of such a sealing element 1, 1′.

As previously addressed, the sealing element 1, 1′ according to the invention can not only be disposed between the cylinder head and cylinder block, but moreover can be used for sealing purposes in the exhaust tract. Given different operating temperatures, different materials will be used.

If the sealing element 1, 1′ according to the invention is to be used in the region of a cylinder head gasket, the material must be suitable for temperatures up to approximately 350° C.

If the sealing element 1, 1′ according to the invention is used, for example, as an exhaust gasket, it must be suitable for use at temperatures >350° C. up to approximately 1000° C.

So as to achieve greater spring deflection, it is now proposed to provide connecting means 5, 5′ in the core region 2, 2′ of each sealing element 1, 1′. In the simplest embodiment, these connecting means 5, 5′ are formed by surface regions 6, 7, 6′, 7′ that run parallel to each other and are provided at different height levels in the core region 2, 2′. The respective increment is defined by reference numeral 8, 8′.

As an alternative, surface regions that are differently shaped, for example convexly/concavely, are also conceivable, however, in this case, the logistical complexity is greater. One sealing element then comprises, for example, a shoulder, while the other sealing element is provided with a correspondingly shaped groove.

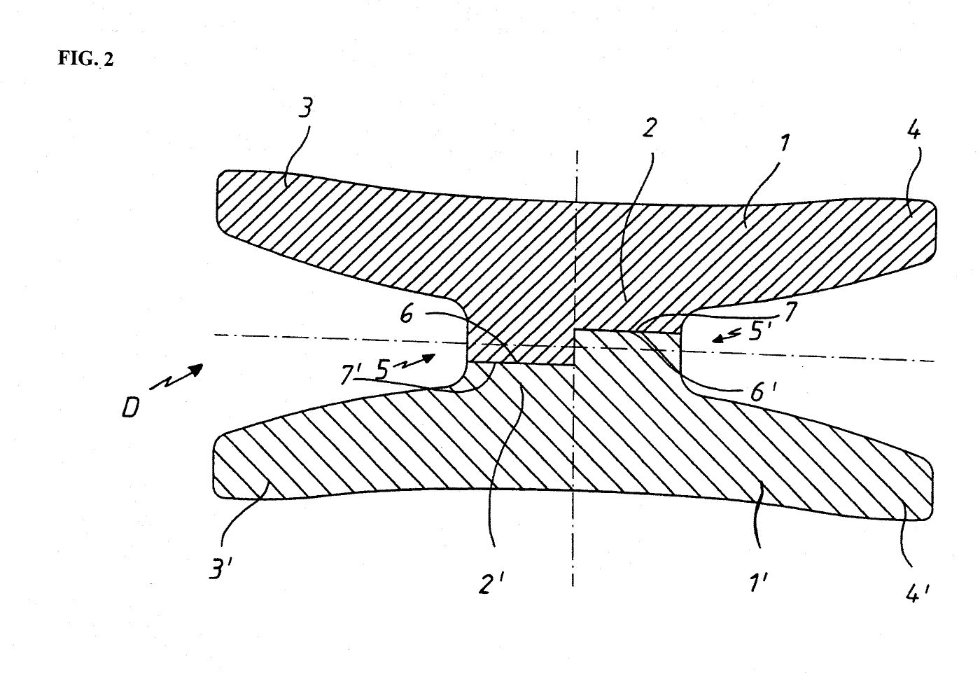

FIG. 2 shows the identically designed individual sealing elements 1, 1′ that are shown in FIG. 1. The inversely profiled connecting means 5, 5′ are now mated inside each other so that the surface regions 6, 7′ and 7, 6′ are located flush on top of one another. A single sealing element D is thus formed by directly connecting the sealing elements 1, 1′, whereby greater spring deflection can be achieved, as compared to an individual sealing element 1, 1′. The respective core regions 2, 2′ and the bending regions 3, 4, 3′, 4′ are apparent.

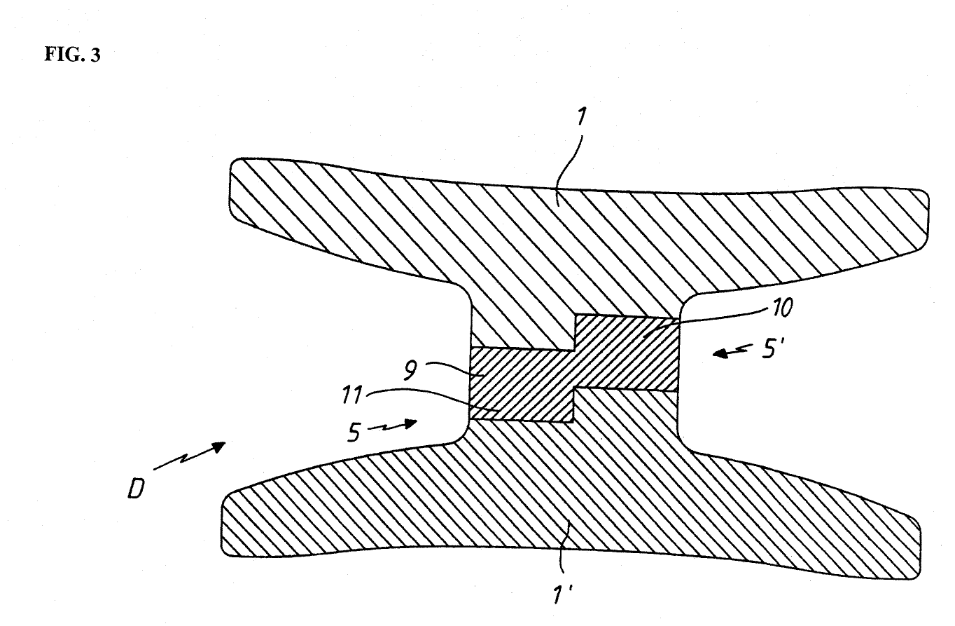

FIG. 3 shows an alternative to FIG. 2. The individual sealing elements 1, 1′ shown in FIG. 1 are used here. Deviating from FIG. 2, a separate connecting element/intermediate piece 9 is provided in FIG. 3 to indirectly connect the individual sealing elements 1, 1′ and is positioned between the connecting means 5, 5′ of the sealing elements 1, 1′. The connecting element/intermediate piece 9 is provided with a counter-profile 10, 11 that is adapted to the respective profile of the connecting means 5, 5′ of the sealing elements 1, 1′. Arbitrary installation heights can be implemented for the assembled sealing element D by way of using connecting elements and intermediate pieces 9 of various heights.

It is likewise conceivable to equip the core region 2, 2′ of each sealing element 1, 1′ with identically curved surface regions and to provide correspondingly shaped counter-profiles in the connecting element/intermediate piece 9. Again, an indirect connection of the individual sealing elements 1, 1′ would then exist, and the logistical complexity—similar to that shown in FIG. 1—would be low.

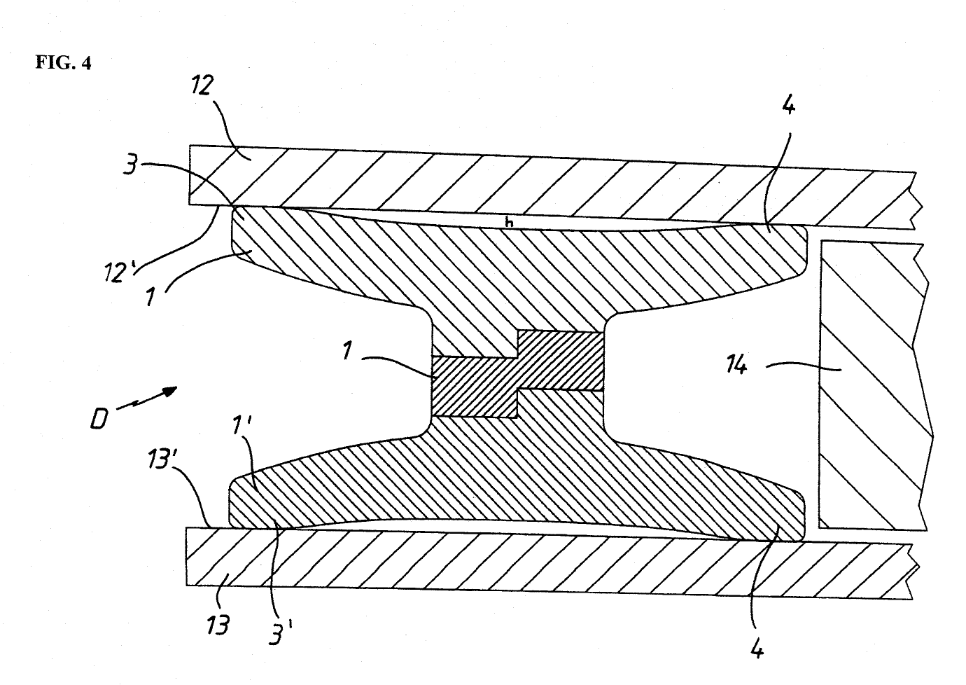

FIG. 4 shows the sealing element D that is formed by the sealing elements 1, 1′ according to FIG. 3, more specifically in the installed state.

Two plate-shaped outer layers 12, 13 of a cylinder head gasket, which is only suggested, and an interposed spacer layer 14 are apparent. The sealing element D assembled from the sealing elements 1, 1′ includes the connecting element/intermediate piece 9. The view shows the layers 12, 13 in a state where they are not yet fully braced, wherein only the bending regions 3, 4, 3′, 4′ rest against the counter-surfaces 12′, 13′ of the layers 12, 13. Further compression of the layers 12, 13 with respect to each other would reduce the gap h, h′ and, if necessary, even bring this toward zero.

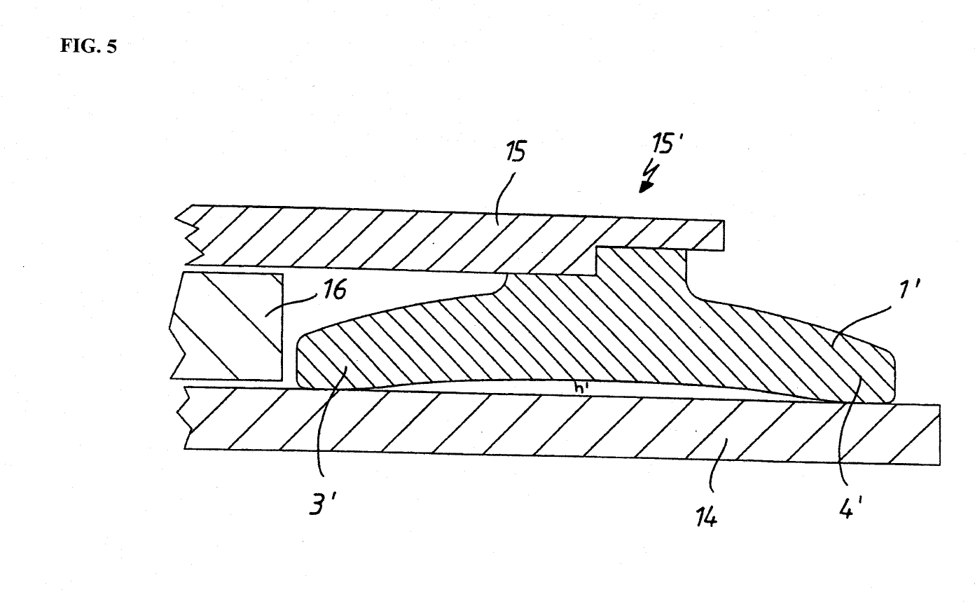

FIG. 5 shows another installation variant. The sealing element 1′ according to FIG. 1 is apparent, which comprises the connecting means 5′. In this example, an outer layer 14 of a cylinder head gasket, which is only suggested, is provided, on which the bending regions 3′, 4′ are supported, forming the gap h′. An additional outer layer 15 is used which, in the same manner as the sealing element 1′, is provided with a connecting means 15′. A spacer layer 16 is again present between the outer layers 14, 15.

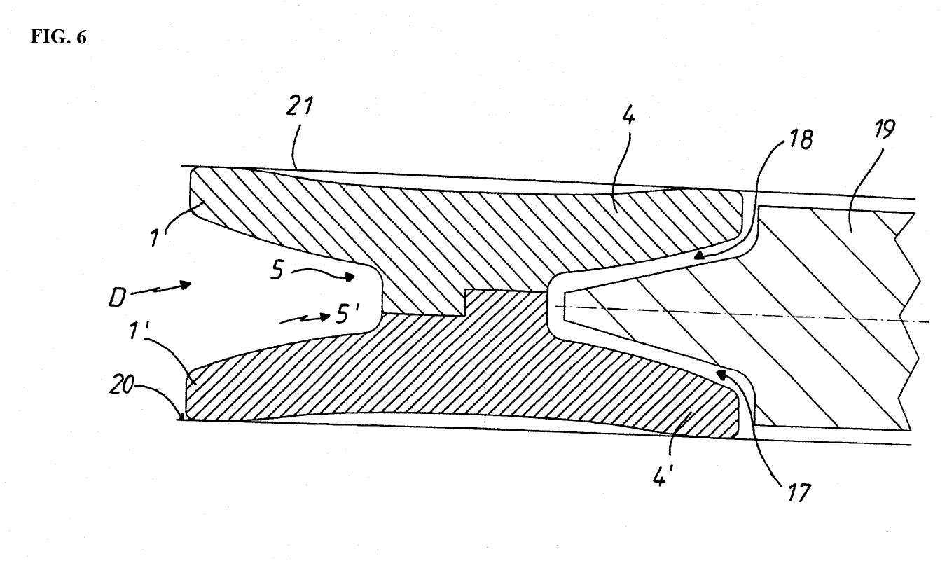

FIG. 6 shows a further alternative to FIGS. 4 and 5. Here, a sealing element D according to FIG. 2, which is composed of the sealing elements 1, 1′, is used. The sealing elements 1, 1′ can be mounted, for example, in a recess 17, 18 of a spacer layer 19 of, for example, a flat gasket, which is not shown in detail, by way of the connecting means 5, 5′. For this purpose, the sealing element 1′ is placed onto the cylinder block 20, with the bending region 4′ resting inside the recess 17. Subsequently, the connecting means 5 of the sealing element 1 are placed on the connecting means 5′ of the sealing element 1′, so that the bending region 4 engages in the recess 19. Reference numeral 21 denotes the cylinder head of an internal combustion engine.

Several alloys are provided hereafter by way of example: All the information is provided in % by weight.

A: Sealing Element for Use in the Region of a Cylinder Head Gasket.

1. Austenitic Steel

C max. 0.15%

Si max. 2%

Mn max. 0.5%

P max. 0.45%

S max. 0.04%

Cr 12-21%

Ni max. 16%

Mo max. 4%

Co max. 4%

remainder Fe

b 2. Martensitic Steel

C 0.16-0.50%

Si max. 1%

Mn max. 1.5%

P max. 0.045%

S max. 0.04%

Cr 12-14.5%

Ni max. 0.75%

Mo max. 1%

remainder Fe

3. Non-Stainless Steel

C 0.5-1.3%

Si max. 3%

Mn max. 3%

P max. 0.035%

S max. 0.035%

Cr max. 2%

remainder Fe

B: Sealing Element for Use in the Region of an Exhaust Flange Gasket.

Depending on the temperature range (>350° C.), nickel-based alloys or nickel-based super alloys can be used. The materials used here for such a sealing element according to the invention are substantially nickel-chromium steels having a chromium content of between 17 and 23% and a nickel content of between 25 and 55%.

All the information for the elements is provided in % by weight.

1. A sealing element for sealing flange faces on internal combustion engines, comprising at least one annular metal profiled body, made of a wire, radial cross-section of the wire comprising at least one core region and two bending regions, the thickness of the sealing element in an axial direction of the sealing element in the core region being greater than in the bending regions, and in the core region at least one connecting means for direct or indirect connection to at least one further component, and the radial cross-section of the sealing element being in the shape of a longitudinal, axial cross-section of a banana, a center region of the banana-shape forming such core region and opposed end regions of the banana-shape forming the bending regions, and a height of the sealing element in an axial direction of the sealing element in the bending regions exceeding a height of the sealing element at the core region in an unstressed state of the sealing element.

2. The sealing element according to claim 1, wherein the connecting means comprise surface regions of the core region that are offset from each other.

3. The sealing element according to claim 2, wherein the surface regions run parallel to each other and are provided at different height levels.

4. The sealing element according to claim 1, wherein the connecting means comprise curved surface regions of the core region.

5. The sealing element according to claim 3, wherein the connecting means further comprises elements which make with said surface regions of the core region.

6.-9. (canceled)

10. The sealing element according to claim 1, wherein the region of the radial extremities of the bending regions are rounded.

11. The sealing element according to claim 1, wherein the axial cross-sectional shapes of the bending regions are identical to each other.

12. The sealing element according to claim 1, wherein thicknesses of the bending regions in the axial direction of the sealing element are different from each other.

13. A cylinder head gasket comprising a sealing element according to claim 1.

14. The cylinder head gasket comprising a combustion chamber through-passage and a sealing element according to claim 29, in the region of the combustion chamber through-passage gasket.

15. The internal combustion engine according to claim 31, wherein the sealing element is situated at a fluid through-passage.

16. A flange gasket comprising the sealing element according to claim 29.

17. An internal combustion engine intake, comprising the sealing element according to claim 29.

18. (canceled)

19. The internal combustion engine according to claim 15, wherein the sealing element is so arranged as to be radially movable.

20. The sealing element according to claim 1, wherein the wire comprises spring steel.

21. The sealing element according to claim 1, wherein the wire has a yield point of ≧600 MPa.

22. The sealing element according to claim 1, wherein the wire comprises an austenitic stainless or other austenitic corrosion-resistant metal.

23. The sealing element according to claim 1, wherein the wire comprises a martensitic stainless or other martensitics corrosion-resistant metal.

24. The sealing element according to claim 1, wherein the wire comprises a non-stainless steel.

25. The sealing element according to claim 1, wherein the wire comprises a nickel-based alloy.

26. The sealing element according to claim 1, wherein the wire comprises a nickel-based super alloy.

27. The sealing element according to claim 1, wherein lines on surfaces of the bending regions at which sealing occurs are at least partially coated.

28. The sealing element according to claim 1, further comprising a further component, the annular metal body and the further component being connected to each other by the connecting means.

29. The sealing element according to claim 28, wherein the further component is a second said annular metal profiled body.

30. An internal combustion engine, comprising the sealing element according to claim 1.

31. An internal combustion engine, comprising the sealing element according to claim 29.

32. The internal combustion engine according to claim 15, wherein the fluid through-passage is a water base or an oil base.

33. An internal combustion engine exhaust comprising the flange gasket according to claim 16.
